(19) United States
(12) Patent Application Publication
(10) Pub. No.: US 2008/0012449 A1
(43) Pub. Date: Jan. 17, 2008

(54) Apparatus for driving actuator

(75) Inventor: Byeung-leul Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/717,060

(22) Filed: Mar. 13, 2007

(30) Foreign Application Priority Data
Jul. 11, 2006 (KR) 10-2006-0065074

(51) Int. Cl. H02N 1/00; G01P 15/125; G01P 1/04

(52) U.S. Cl. 310/309; 73/514.32

(57) ABSTRACT

An apparatus for driving an actuator includes a power unit, a sensing unit, and a first outer capacitor. The power unit provides first and second power in mutually reverse phases to first and second activating vibration plate, respectively. The sensing unit senses a displacement of a suspended vibration plate according to a result of sensing by a sensing plate. The first outer capacitor is disposed between a first power terminal connecting the power unit to the actuator and a sensing terminal connecting the sensing plate to the sensing unit.

### CROSS-REFERENCE TO RELATED PATENT APPLICATION

This application claims the priority from Korean Patent Application No. 10-2006-0065074, filed on Jul. 11, 2006, in the Korean Intellectual Property Office, the disclosure of which is incorporated herein in its entirety by reference.

### BACKGROUND OF THE INVENTION

1. Field of the Invention

Apparatuses consistent with the present invention relate to driving an actuator, and more particularly, to an apparatus for driving an actuator capable of giving the actuator highly sensitive performance by offsetting parasitic distribution capacitances.

2. Description of the Related Art

A micromechanical resonant actuator has been an essential element of a highly sensitive sensor converting potential or kinetic energy. In particular, active research has been carried out on a micro gyroscope capable of detecting an angular velocity using a resonator as well as a sensor for sensing pressure, acceleration and gas distribution based on a change in a resonant frequency of the resonator having extremely low attenuation.

An apparatus for driving a conventional comb driven type micro actuator includes a combed activating vibration plate fixed by a fixing portion, a combed sensing plate fixed by the fixing portion, a combed suspended vibration plate supported by a support beam and the fixing portion, a ground plate grounded by a ground electrode, and a sensing unit. A power unit supplies alternating current (AC) and direct current (DC) power to the activating vibration plate via the fixing portion. If the power is supplied to the activating vibration plate from the power unit, an electrostatic force is generated between the teeth of the combed activating vibration plate and the teeth of the suspended vibration plate, so that the suspended vibration plate vibrates at a resonant frequency. A sensing unit senses a change in capacitance according to a change in the opposing areas between the teeth of the combed sensing plate and the teeth of the suspended vibration plate, as a voltage change. Also, among the related art comb driven type micro actuators there is a conventional comb driven type micro actuator having a construction that allows the activating vibration plate to be divided into a first and second activating vibration plate and allows the power from the power unit to be supplied to the first and second activating vibration plate, respectively.

An apparatus for driving a conventional parallel plate type micro actuator has a sensing plate at the center thereof, activating vibration plates at both sides of the sensing plate, and a suspended vibration plate over the activating vibration plates and the sensing plate. In the circuit of the micro actuator, a sensing unit is connected to the sensing plate. Also, there is a power unit providing AC and DC power to the activating vibration plates. If the power is supplied to the activating vibration plate from the power unit, an electrostatic force is generated between the activating vibration plate and the suspended vibration plate, so that the suspended vibration plate vibrates up and down at a resonant frequency. The sensing unit senses a change in a capacitance according to a change in distance between the sensing plate and the suspended vibration plate, as a voltage.

Vibration characteristics of the electrostatic driven micro actuator can be easily understood using an optical unit such as a laser interferometer. Using such an optical unit could cause problems such as an increase in cost and volume of the device. In order to solve these problems, a simple circuit capable of detecting a change in a capacitance according to the vibration is necessary for applying the vibration characteristics to a sensor. However, since a vibration displacement of a resonator is very small, a change in a signal based on the change in the capacitance that is to be sensed is very small, so that it is difficult to apply a simple circuit capable of detecting a change in a capacitance to the micro actuator. In particular, when sensing the displacement of the moving resonator (vibration plate) as the change in the capacitance while resonating a micro vibration member formed on a silicon substrate, parasitic capacitance exists between the activating vibration plate generating a vibration signal and the sensing plate detecting a sensing signal. The parasitic capacitance forms a path for transmitting noise, so that the noise is transferred to the sensing unit and is mixed with the sensing signal. Due to the parasitic capacitance, the activating vibration signal mixed with the sensing signal acts as a noise source which lowers sensitivity in the detection of a sensing signal. To reduce the noise caused by the parasitic capacitance, the activating vibration plate provided to the comb driven type micro actuator or the parallel plate type micro actuator is divided into the first and the second activating vibration plate and power of a reverse phase is supplied to the first and second activating vibration plate, respectively, in order to minimize the effect of the parasitic capacitance. However, in this configuration, when a difference between a first parasitic capacitance (formed by the first activating vibration plate, the suspended vibration plate, and the sensing plate), and a second parasitic capacitance (formed by the second activating vibration plate, the suspended vibration plate, and the sensing plate), is large, noise increases and a signal-to-noise ratio is reduced.

FIG. 1 illustrates an example of a signal-to-noise ratio according to a related art apparatus for driving an actuator. \textcircled{1} and \textcircled{2} in FIG. 1 are curves illustrating frequency response characteristics when there is a large difference between a first parasitic capacitance “Cp1” and a second parasitic capacitance “Cp2”, and \textcircled{3} in FIG. 1 is a curve illustrating frequency response characteristics when there is a small difference between a first parasitic capacitance “Cp1” and a second parasitic capacitance “Cp2”. As illustrated in \textcircled{1} and \textcircled{2} in FIG. 1, when the difference between the first parasitic capacitance “Cp1” and the second parasitic capacitance “Cp2” is large, the signal-to-noise ratio is small so that the sensitivity in the detection is lowered. In the meantime, as illustrated in \textcircled{3} in FIG. 1, because the difference between the first parasitic capacitance “Cp1” and the second parasitic capacitance “Cp2” is small, the signal-to-noise ratio is relatively larger than with \textcircled{1} and \textcircled{2} in FIG. 1. Therefore, to solve this problem, a circuit making the first parasitic capacitance “Cp1” similar to the second parasitic capacitance “Cp2” is needed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus for driving an actuator and improving a signal-to-noise ratio and vibration characteristics.

According to an aspect of the present invention, there is provided an apparatus for driving an actuator having a first activating vibration plate, a second activating vibration plate separated from the first activating vibration plate, a suspended vibration plate, and a sensing plate, the apparatus including a power unit providing first and second power in mutually reverse phases to the first and second activating vibration plate, respectively, a sensing unit sensing a displacement of the suspended vibration plate according to a result of sensing by the plate, and a first outer capacitor provided between a first power terminal connecting the power unit to the actuator so as to provide the first power and a sensing terminal connecting the sensing plate to the sensing unit.

### BRIEF DESCRIPTION OF THE DRAWINGS

FIG. 1 is a graph illustrating an example of a signal-to-noise ratio of a related art apparatus for driving an actuator.

FIG. 2 is a block diagram illustrating an apparatus for driving an actuator according to an exemplary embodiment of the present invention.

FIG. 3 is a diagram illustrating an actuator and a power unit according to an exemplary embodiment of the present invention.

FIG. 4 is a graph comparing an improved signal-to-noise ratio of the apparatus illustrated in FIG. 2 with the related art.

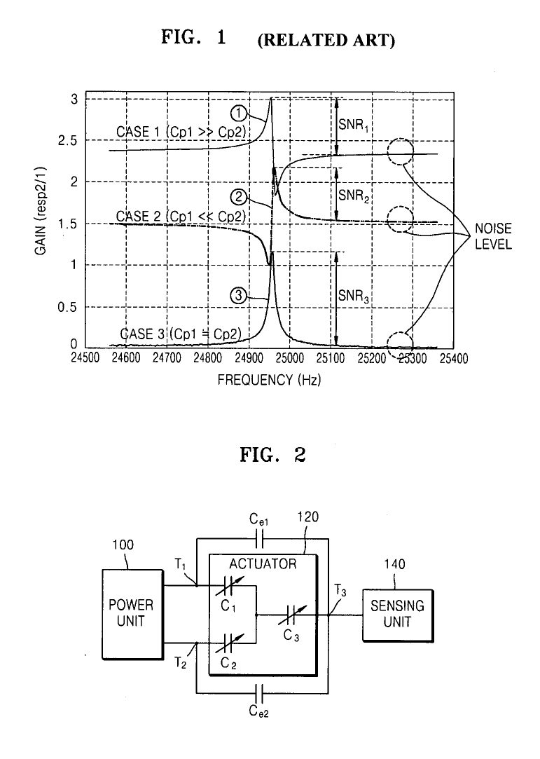

### DETAILED DESCRIPTION OF THE EXEMPLARY EMBODIMENTS

An apparatus for driving an actuator according to an exemplary embodiment of the present invention will now be described more fully with reference to the accompanying drawings.

FIG. 2 is a block diagram illustrating an apparatus for driving an actuator according to an exemplary embodiment of the present invention. The apparatus includes a power unit 100, an actuator 120 and a sensing unit 140.

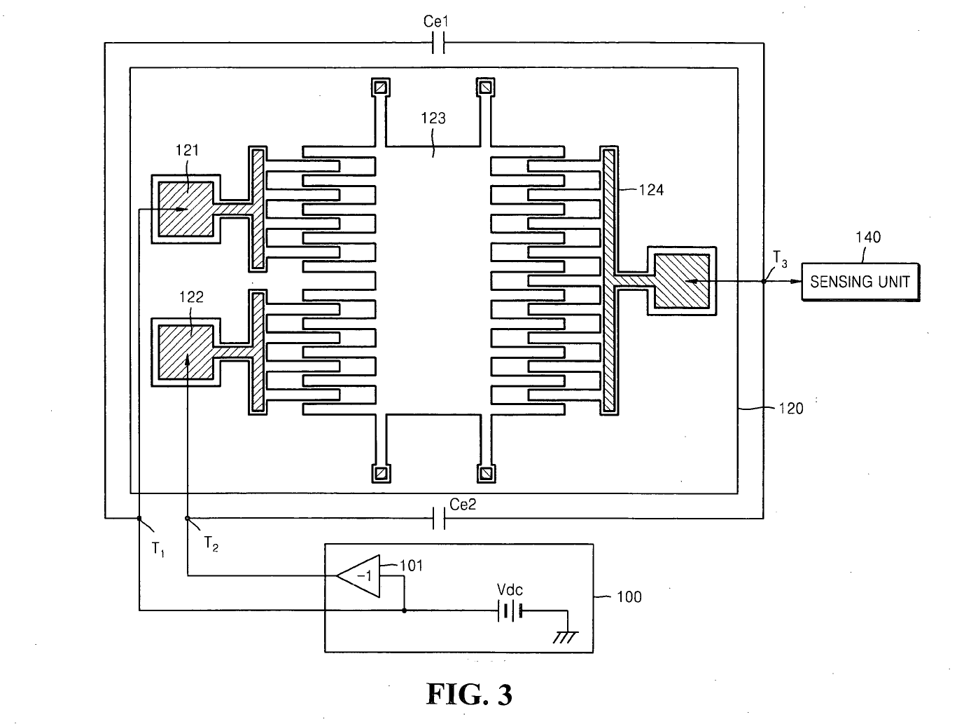

As illustrated in FIG. 3, the actuator 120 includes a first activating vibration plate 121, a second activating vibration plate 122, a suspended vibration plate 123 and a sensing plate 124. The actuator 120 includes a general electrostatic actuator such as a comb type micro actuator or a conventional parallel plate type micro actuator.

A first power capacitor C1 in the actuator 120 in FIG. 2 represents changes in the capacitance between the first activating vibration plate 121 and the suspended vibration plate 123 due to vibration of the plates, and a second power capacitor C2 represents changes in the capacitance between the second activating vibration plate 122 and the suspended vibration plate 123 due to vibration of the plates. Also, a sense capacitor C3 represents changes in the capacitance between the sensing plate 124 and the suspended vibration plate 123 due to vibration of plates.

The power unit 100 illustrated in FIG. 3 provides power to the actuator 120, and has an inverter 101. The power unit 100 directly provides a first power to the first activating vibration plate 121 of the actuator 120 and provides a second power, which is in a reverse phase compared to the first power provided to the first activating vibration plate 121 to the second activating vibration plate 122 of the actuator 120 via the inverter 101.

The sensing unit 140 senses a displacement of the suspended vibration plate 123 according to a result of sensing by the sensing plate 124.

The power provided to the first activating vibration plate 121 and that provided to the second activating vibration plate 122 are in reverse phases to each other so that an electrostatic force is generated at the first activating vibration plate 121 and the second activating vibration plate 122 respectively. Here, an AC considered as noise is transmitted to the sensing unit 140 by a parasitic capacitance in the actuator 120. Since the noise is also reversed in phase, it is offset and the signal-to-noise ratio is improved. However, in order to maximize the effect of the noise offset, the difference between a first parasitic capacitance formed by the first activating vibration plate 121, the suspended vibration plate 123, and the sensing plate 124 and a second parasitic capacitance formed by the second activating vibration plate 122, the suspended vibration plate 123, and the sensing plate 124 should be minimized. In order to gain the effect of the noise offset, a first outer capacitor Cₑ₁ and a second outer capacitor Cₑ₂ may be provided since the first parasitic capacitance and the second parasitic capacitance do not generally coincide.

The first outer capacitor Cₑ₁ is provided between a first power terminal T₁, which connects the power unit 100 to the actuator 120 in order to provide the first power, and a sensing terminal T₃, which connects the sensing plate 124 of the actuator 120 to the sensing unit 140.

The second outer capacitor Cₑ₁ is provided between a second power terminal T₂, which provides the second power and connects the power unit 100 to the actuator 120, and the sensing terminal T₃.

In order to minimize the noise made by the difference between the first parasitic capacitance and the second parasitic capacitance in the actuator 120, capacitance of one or both of the first outer capacitor (Cₑ₁) and the second outer capacitor (Cₑ₂) is adjusted so that the first parasitic capacitance and the second parasitic capacitance are similar. The adjustment may be done by means of a repeated test according to a result of sensing by the sensing unit 140 during the designing stage of the apparatus for driving the actuator 120.

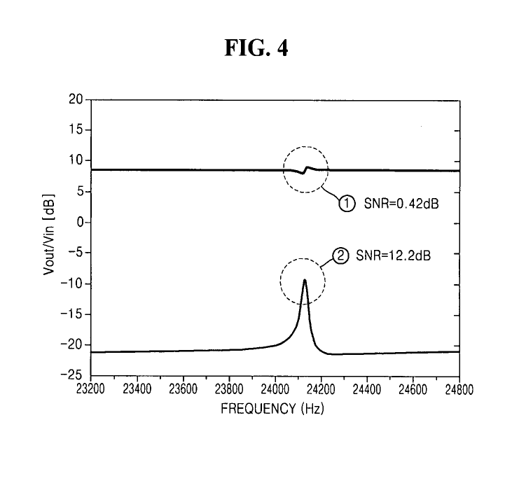

FIG. 4 is a graph comparing an improved signal-to-noise ratio of the apparatus illustrated in FIG. 2 with the related art.

\textcircled{1} in FIG. 4 illustrates a result of the signal-to-noise ratio according to the related art. When power in a reverse phase is provided to two activating vibration plates, respectively, the signal-to-noise ratio (SNR=0.42 dB) is small because of the difference between a first parasitic capacitance and a second parasitic capacitance.

\textcircled{2} in FIG. 4 illustrates a result of the signal-to-noise ratio according to an exemplary embodiment of the present invention. When power in a reverse phase is provided to two activating vibration plates, respectively, the signal-to-noise ratio (SNR=12.2 dB) is large because the difference between a first parasitic capacitance and a second parasitic capacitance is minimized by a first outer capacitor Cₑ₁ and a second outer capacitor Cₑ₂. The fact that the signal-to-noise ratio is large signifies excellent detection ability.

The apparatus for driving the actuator 120 is provided so that an apparatus may form an image by using a device such as a printer or a scanner.

The apparatus for driving the actuator 120 according to the present invention, improves the signal-to-noise ratio by adding the outer capacitor that allows the parasitic capacitances to be similar to each other in order prevent an activating vibration signal mixing with a sensing signal, which generates noise through parasitic capacitance caused by the construction of the actuator 120 and vibration characteristics. Also, since the sensing unit 140 is embodied by using a simple capacitance detecting type circuit the cost of manufacturing the driving apparatus can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for driving an actuator which comprises a first activating vibration plate, a second activating vibration plate separated from the first activating vibration plate, a suspended vibration plate, and a sensing plate, the apparatus comprising:
a power unit which provides first and second power in mutually reverse phases to the first and second activating vibration plates, respectively;
a sensing unit which senses a displacement of the suspended vibration plate according to a result of sensing by the sensing plate; and
a first outer capacitor which is disposed between a first power terminal which connects the power unit to the actuator to provide the first power, and a sensing terminal which connects the sensing plate to the sensing unit.

2. The device of claim 1, further comprising a second outer capacitor disposed between a second power terminal which connects the power unit to the actuator to provide the second power, and the sensing terminal.

3. The device of claim 1, wherein the power unit comprises an inverter, provides the first power directly to the first activating vibration plate and provides the second power in a reverse phase with respect to the first power, to the second activating vibration plate via the inverter.

4. The device of claim 1, wherein the actuator is one of a comb type micro actuator and a parallel plate type micro actuator.

5. The device of claim 2, wherein a capacitance of the first outer capacitor and a capacitance of the second outer capacitor are adjusted to offset a noise caused by a parasitic capacitance in the actuator.

6. An image forming apparatus comprising an apparatus for driving an actuator which comprises a first activating vibration plate, a second activating vibration plate separated from the first activating vibration plate, a suspended vibration plate, and a sensing plate, the apparatus for driving an actuator comprising:
a power unit which provides first and second power in mutually reverse phases to the first and second activating vibration plates, respectively;
a sensing unit which senses a displacement of the suspended vibration plate according to a result of sensing by the sensing plate; and
a first outer capacitor which is disposed between a first power terminal which connects the power unit to the actuator to provide the first power, and a sensing terminal which connects the sensing plate to the sensing unit.

7. The image forming apparatus of claim 6, further comprising a second outer capacitor disposed between a second power terminal which connects the power unit to the actuator to provide the second power, and the sensing terminal.

8. The image forming apparatus of claim 6, wherein the power unit comprises an inverter, provides the first power directly to the first activating vibration plate and provides the second power in a reverse phase with respect to the first power, to the second activating vibration plate via the inverter.

9. The image forming apparatus of claim 6, wherein the actuator is one of a comb type micro actuator and a parallel plate type micro actuator.

10. The image forming apparatus of claim 7, wherein a capacitance of the first outer capacitor and a capacitance of the second outer capacitor are adjusted to offset a noise caused by a parasitic capacitance in the actuator.
